(19) United States
(12) Patent Application Publication
(10) Pub. No.: US 2020/0033597 A1
(43) Pub. Date: Jan. 30, 2020

(54) PROTECTION COVER, PROTECTION DEVICE AND PROTECTION METHOD FOR HEAD UP DISPLAY

(71) Applicant: BOE TECHNOLOGY GROUP CO., LTD., Beijing (CN)

(72) Inventors: Naifu WU, Beijing (CN); Dianmeng LI, Beijing (CN)

(21) Appl. No.: 16/448,464

(22) Filed: Jun. 21, 2019

(30) Foreign Application Priority Data
Jul. 25, 2018 (CN) 201810827099.0

(51) Int. Cl. G02B 27/01; G02F 1/1516; B32B 17/10

(52) U.S. Cl. CPC G02B 27/0101; G02F 1/15165; B32B 17/10513; B32B 17/1044; G02B 2027/012; G02B 2027/0183; B60K 2370/682; B60K 2370/1529; B32B 17/10174

(57) ABSTRACT

The present disclosure provides a protection cover, a protection device, and a protection method for a head up display. The protection cover includes a front cover, a color changing layer, and a rear cover, which are disposed in a stack. An electrochromic material is provided in the color changing layer, and the color changing layer is configured to adjust a light transmittance under an action of an electric field to protect the head up display.

### CROSS REFERENCE TO RELATED APPLICATIONS

The present application is based upon and claims priority of Chinese Patent Application No. 201810827099.0, filed on Jul. 25, 2018, the entire disclosure of which being hereby incorporated by reference as a part of the present application.

### TECHNICAL FIELD

The present disclosure relates to the field of display technology and, more particularly, to a protection cover, a protection device, and a protection method for a head up display.

### BACKGROUND

A head up display (HUD) is a flight aid instrument used on aircrafts. By using the HUD, a pilot can see important information it needs without looking down. Recently, HUDs have also been installed on vehicles. The car HUD utilizes an optical system to project images (such as navigation information) onto the windshield. Since the HUD is directly exposed to sunlight, the HUD can easily deteriorate or be damaged by long-term exposure to sunlight.

It should be noted that the information disclosed in the Background section above is only for enhancing understanding of the background of the present disclosure, and thus may include information that does not constitute prior art known to those of ordinary skill in the art.

### SUMMARY

The present disclosure provides a protection cover, a protection device, and a protection method for a head up display (HUD).

In order to solve the problems above, the present disclosure discloses a protection cover, the protection cover including a front cover, a color changing layer, and a rear cover, which are disposed in a stack;

an electrochromic material is provided in the color changing layer, and the color changing layer is configured to adjust a light transmittance under an action of an electric field.

Optionally, the color changing layer includes a first electrode and a second electrode disposed opposite to each other, and an electrolyte layer disposed between the first electrode and the second electrode;

the electrochromic material is contained in the electrolyte layer; and

the electrochromic material is attracted onto the first electrode or the second electrode under the action of the electric field to change the light transmittance of the color changing layer.

Optionally, the electrochromic material includes an inorganic electrochromic material and an organic electrochromic material;

the inorganic electrochromic material includes tungsten trioxide; and

the organic electrochromic material includes at least one of a polythiophene, a polythiophene derivative, a viologen, a tetrathiafulvalene, and a metal phthalocyanine compound.

Optionally, the front cover and the rear cover are both formed of transparent materials; and

the transparent materials include either or both glass and acrylic.

An embodiment of the present disclosure also provides a protection device for the head up display, including the protection cover, described above, and a control module coupled to the color changing layer of the protection cover;

wherein the control module is configured to input a control signal to the color changing layer to control the electric field generated by the color changing layer.

Optionally, the control module is configured to determine whether a current state of the head up display meets a preset condition and, when the preset condition is met, control the electric field to adjust the transmittance of the color changing layer; and

the preset condition includes that the head up display is in a non-operating state and the illumination intensity is greater than a preset value.

Optionally, the non-operating state includes at least one of the head up display being in a turned-off state, and a vehicle, in which the head up display is located, being in a stopped state.

An embodiment of the present disclosure also provides a method for protecting a head up display, which is applied to a protection device for a head up display described above, the method including:

determining whether a current state of the head up display meets a preset condition; wherein the preset condition includes that the head up display is in a non-operating state and the illumination intensity is greater than a preset value; and

when the preset condition is met, adjusting a light transmittance of the protection device to protect the head up display.

Optionally, the non-operating state includes at least one of the head up display being in a turned-off state, and a vehicle, in which the head up display is located, being in a stopped state.

Optionally, the method further includes:

when the preset condition is not met, adjusting the light transmittance of the protection device to an initial value.

It should be understood that both the foregoing general description and the following detailed description are exemplary and explanatory only and are not restrictive of the disclosure.

### BRIEF DESCRIPTION OF THE DRAWINGS

FIG. 1 is a first schematic structural diagram of a protection cover according to an embodiment of the present disclosure;

FIG. 2 is a second schematic structural diagram of a protection cover according to an embodiment of the present disclosure;

FIG. 3 is a schematic structural diagram of a protection device for a head up display according to an embodiment of the present disclosure; and

FIG. 4 is a flow chart showing the steps of a method for protecting a head up display according to an embodiment of the present disclosure.

### DETAILED DESCRIPTION

In order to make the above objectives, features, and advantages of the present disclosure become more apparent, the present disclosure will be further described in detail with reference to the accompanying drawings and specific embodiments.

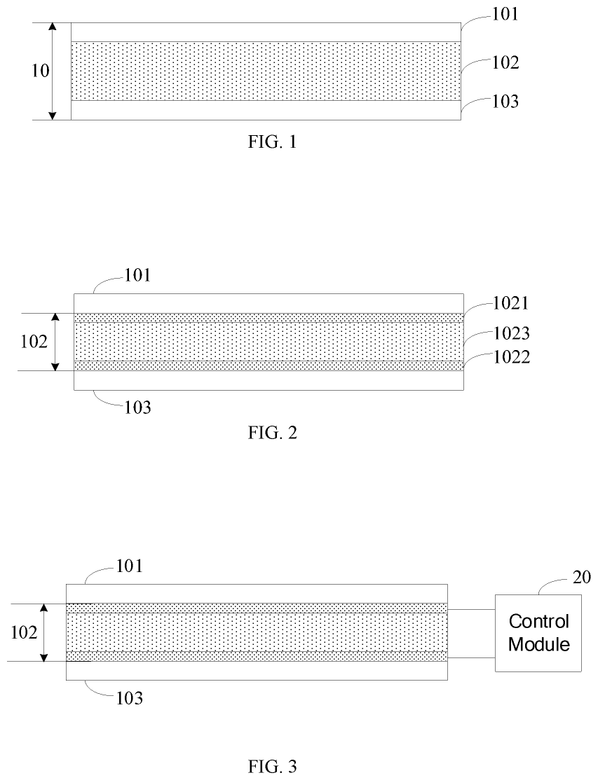

Referring to FIG. 1, a schematic structural diagram of a protection cover according to an embodiment of the present disclosure is shown. The protection cover 10 includes a front cover 101, a color changing layer 102, and a rear cover 103 disposed in a stack.

An electrochromic material is disposed in the color changing layer 102, and the color changing layer 102 is configured to adjust a light transmittance under an action of an electric field to protect the head up display.

In this embodiment, the protection cover 10 includes a front cover 101, a color changing layer 102, and a rear cover 103. The color changing layer 102 contains an electrochromic material, and the electrochromic material can adjust the light transmittance of the color changing layer 102 under the action of the electric field. For example, when there is no electric field, the color changing layer 102 can transmit visible light and infrared light, and the light transmittance is greater than 95%. When the electric field is weak, the color changing layer 102 can only transmit visible light, and the light transmittance is about 50%. When the electric field is strong, neither visible light nor infrared light can pass through the color changing layer 102, and the color changing layer 102 has a light transmittance of less than 10%. The protection cover 10 is placed on the head up display, and the light transmittance is adjusted by the color changing layer 102. In this way, it can prevent the head up display from being deteriorated or damaged due to exposure to strong sunlight, and can protect the head up display.

Optionally, referring to the structural schematic diagram of the protection cover shown in FIG. 2, the color changing layer 102 includes a first electrode 1021 and a second electrode 1022 disposed opposite to each other, and an electrolyte layer 1023 disposed between the first electrode 1021 and the second electrode 1022.

The electrolyte layer 1023 contains an electrochromic material.

The electrochromic material is attracted onto the first electrode 1021 or the second electrode 1022 under the action of the electric field to change the light transmittance of the color changing layer 102.

In this embodiment, the first electrode 1021 may be provided as an anode, and the second electrode 1022 may be provided as a cathode; or the first electrode 1021 may be provided as a cathode, and the second electrode 1022 may be provided as an anode, which is not specifically limited in the embodiment of the present disclosure, and may be provided according to actual conditions. An electric field can be generated by the first electrode 1021 and the second electrode 1022, and the electrochromic material in the electrolyte layer 1023 is attracted onto the first electrode 1021 or the second electrode 1022 under the action of the electric field. For example, an electrochromic material is attracted onto a cathode by an electric field. When the electric field is weak, less electrochromic material is attracted to the cathode, and the light transmittance of the color changing layer 102 is higher; and when the electric field is strong, more electrochromic material is attracted to the cathode, and the light transmittance of the color changing layer 102 is lower.

Optionally, the electrochromic material includes an inorganic electrochromic material and an organic electrochromic material.

The inorganic electrochromic material includes tungsten trioxide.

The organic electrochromic material includes at least one of a polythiophene, a polythiophene derivative, a viologen, a tetrathiafulvalene, and a metal phthalocyanine compound.

The electrochromic material is not limited specifically in the embodiment of the present disclosure and may be selected according to actual conditions.

Optionally, the front cover and the rear cover are both formed of a transparent material.

The transparent material includes at least one of glass and acrylic.

In sum, in the embodiment of the present disclosure, the protection cover includes a front cover, a color changing layer, and a rear cover which are disposed in a stack; an electrochromic material is provided in the color changing layer, and the electrochromic material adjusts a light transmittance of the color changing layer under the action of the electric field. In this way, it can prevent the head up display from deteriorating or being damaged due to exposure to strong sunlight, and can protect the head up display. It can prolong the service life of the head up display and improve the user experience.

Referring to FIG. 3, a schematic structural diagram of a protection device for a head up display is provided in an embodiment of the present disclosure. The head up display includes a protection cover 10 as described in the embodiment above, and a control module 20 coupled to the color changing layer 102 of the protection cover 10.

The control module 20 is configured to input a control signal to the color changing layer 102 to control the electric field generated by the color changing layer 102.

In this embodiment, the protection device of the head up display includes a protection cover 10 and a control module 20, and the control module 20 is coupled to the color changing layer 102 of the protection cover 10. The control module 20 can input a control signal to the color changing layer 102, and the color changing layer 102 generates an electric field according to the control signal, such that the electrochromic material in the color changing layer 102 is attracted onto the first electrode 1021 or the second electrode 1022. The control module 20 can adjust the light transmittance of the color changing layer 102 by controlling the electric field generated by the color changing layer 102, thereby preventing the head up display from being illuminated by strong light, and protecting the head up display.

Optionally, the control module 20 is configured to determine whether the current state of the head up display meets a preset condition and, if the preset condition is met, control the electric field to adjust the transmittance of the color changing layer 102.

The preset condition includes the head up display being in a non-operating state and the illumination intensity being greater than a preset value.

In the embodiment, when controlling the electric field generated by the color changing layer 102, the control module 20 first determines whether it is necessary to adjust the light transmittance of the protection cover 10 to protect the head up display, that is, whether the current state of the head up display meets the preset condition. Specifically, it is determined whether the head up display is in a non-operating state, and it is determined whether the illumination intensity is greater than a preset value. If the head up display is not operating and the illumination intensity is greater than the preset value, then it indicates that the head up display needs to be protected. At this time, the electric field of the color changing layer 102 is controlled to lower the light transmittance of the color changing layer 102, to prevent the head up display from being irradiated by strong light.

Optionally, the non-operating state includes at least one of the head up display being in a turned-off state, and the vehicle, in which the head up display is located, being in a stopped state.

In the embodiment, the non-operating state of the head up display may be that the head up display is in a turned-off state. For example, when the head up display is not required to assist driving, the user may turn off the head up display. The non-operating state may also be that the vehicle is in a stopped state. For example, if the vehicle speed is 0, or when the engine is turned off, no head up display assistance is required. At this time, the color changing layer 102 can be controlled to reduce the light transmittance and protect the head up display.

In sum, in the embodiment of the present disclosure, the protection device for the head up display includes a protection cover and a control module, and the control module inputs a control signal to the color changing layer of the protection cover to control the electric field generated by the color changing layer, thereby adjusting the light transmittance of the protection cover and, in turn, protecting the head up display. It can prevent the head up display from deteriorating or being damaged due to exposure to strong sunlight, and can prolong the service life of the head up display, and improve the user experience.

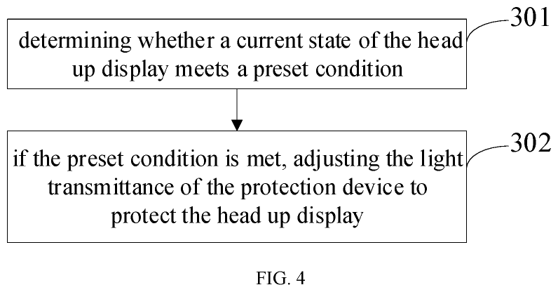

Referring to FIG. 4, a flow chart of steps of a method for protecting a head up display according to an embodiment of the present disclosure is shown. The method is applied to a protection device for a head up display as described in the embodiment. The method includes the following steps.

In step 301, it is determined whether a current state of the head up display meets a preset condition; wherein the preset condition includes whether the head up display is in a non-operating state, and an illumination intensity is greater than a preset value.

In this embodiment, it is first determined whether the current state of the head up display meets the preset condition, that is, whether the head up display needs to be protected. Specifically, it is determined whether the head up display is in a non-operating state, and it is determined whether the illumination intensity is greater than a preset value; and when the head up display is in a non-operating state, and the illumination intensity is greater than a preset value, it is determined that the current state of the head up display meets the preset condition. If the head up display is in operation, or the illumination intensity is not greater than the preset value, it is determined that the current state of the head up display does not satisfy the preset condition. The embodiment of the present disclosure does not limit the illumination intensity in detail, and it may be set according to actual conditions.

Optionally, the non-operating state includes at least one of the head up display being in a turned-off state, and the vehicle, in which the head up display is located, being in a stopped state.

For example, if the user turns off the head up display, or if the vehicle in which the head up display is located has a vehicle speed of 0, or if the engine of the vehicle is turned off, the head up display is in a non-operating state. The non-operating state is not limited specifically in the embodiment of the present disclosure and may be set according to actual conditions.

In step 302, if the preset condition is met, the light transmittance of the protection device is adjusted to protect the head up display.

In the embodiment, when the current state of the head up display meets the preset condition, the head up display needs to be protected so that the light transmittance of the protection device is adjusted, such that part of the light cannot be irradiated onto the head up display, preventing the head up display from being illustrated with strong light and deteriorating and being damaged. It can prolong the service life of the head up display and improve the user experience.

Optionally, if the preset condition is not met, the light transmittance of the protection device is adjusted to an initial value.

Specifically, if the head up display is in an operating state, or the illumination intensity is lower than a preset value, the light transmittance of the protection device is adjusted to an initial value. The initial value may be greater than 90% or greater than 80%. The initial value is not limited specifically in the embodiment of the present disclosure and may be set according to actual conditions.

In sum, in the embodiment of the present disclosure, it is determined whether the current state of the head up display meets the preset condition. If the preset condition is met, the light transmittance of the protection device is adjusted to protect the head up display, and the head up display is prevented from being illuminated with strong light and getting deteriorated and damaged. It can prolong the service life of the head up display and improve the user experience.

Compared with the related art, the present disclosure presents the following advantages:

the protection cover includes a front cover, a color changing layer, and a rear cover which are disposed in a stack; an electrochromic material is provided in the color changing layer, and the electrochromic material adjusts a light transmittance of the color changing layer under the action of the electric field. In this way, it can prevent the head up display from being deteriorated or damaged due to exposure to strong sunlight, and can protect the head up display. It can prolong the service life of the head up display and improve the user experience.

The various embodiments in the present specification are described in a progressive manner, and each embodiment focuses on differences from other embodiments, and the same similar parts between the various embodiments can be referred to each other.

Finally, it should also be noted that in this context, relational terms such as first and second are used merely to distinguish one entity or operation from another entity or operation and do not necessarily require or imply there is any such actual relationship or order between these entities or operations. Furthermore, the terms “including” or “comprising” or any other variations are intended to encompass a non-exclusive inclusion, such that a process, a method, an article, or a device that including a set of elements includes not only those elements, but also includes other elements explicitly listed, or it also includes elements inherent to such a process, a method, an article, or a device. An element defined by the phrase “comprising a . . . ” does not exclude the presence of additional equivalent elements in the process, the method, the article, or the device including the element.

The protection cover and the protection device and the protection method of the head up display provided by the present disclosure are described in detail. The principle and the embodiment of the present disclosure are described in the following. The description of the above embodiment is only to help understand the method of the present disclosure and its core ideas. In addition, for those of ordinary skill in the art, depending on the idea of the present disclosure, there will be changes in specific embodiments and applications. Therefore, the present disclosure is not limited by the scope of the present disclosure.

What is claimed is:

1. A protection cover, comprising:
a front cover, a color changing layer, and a rear cover which are disposed in a stack;
an electrochromic material is provided in the color changing layer; and
wherein the color changing layer is configured to adjust a light transmittance under an action of an electric field.

2. The protection cover according to claim 1, wherein:
the color changing layer comprises a first electrode and a second electrode disposed opposite to each other, and an electrolyte layer disposed between the first electrode and the second electrode;
the electrochromic material is contained in the electrolyte layer; and
the electrochromic material is attracted onto the first electrode or the second electrode under the action of the electric field to change the light transmittance of the color changing layer.

3. The protection cover according to claim 1, wherein the color changing layer is transparent to a visible light and an infrared light when the electric field is not present.

4. The protection cover according to claim 1, wherein the color changing layer has a reduced transmittance to a visible light and an infrared light when the electric field is applied.

5. The protection cover according to claim 1, wherein the electrochromic material comprises an inorganic electrochromic material, the inorganic electrochromic material comprising tungsten trioxide.

6. The protection cover according to claim 1, wherein the electrochromic material comprises an organic electrochromic material, the organic electrochromic material comprising at least one of: a polythiophene, a polythiophene derivative, a viologen, a tetrathiafulvalene, and a metal phthalocyanine compound.

7. The protection cover according to claim 1, wherein:
the front cover and the rear cover are both formed of transparent material; and
the transparent material comprises at least one of: glass and acrylic.

8. A protection device for a head up display, comprising:
a front cover, a color changing layer, and a rear cover which are disposed in a stack;
an electrochromic material is provided in the color changing layer, the color changing layer being configured to adjust a light transmittance under an action of an electric field; and
a controller coupled to the color changing layer of the protection cover, wherein the controller is configured to input a control signal to the color changing layer to control the electric field.

9. The protection device according to claim 8, wherein:
the controller is configured to determine whether a current state of the head up display meets a preset condition and, when the preset condition is met, control the electric field to adjust the transmittance of the color changing layer; and
the preset condition comprises that the head up display is in a non-operating state and an illumination intensity is greater than a preset value.

10. The protection device according to claim 9, wherein the non-operating state comprises at least one of: the head up display being in a turned-off state; and a vehicle, in which the head up display is located, being in a stopped state.

11. The protection device according to claim 9, wherein the controller is configured to apply the electric field to the color changing layer when the current state of the head up display meets the preset condition.

12. The protection device according to claim 9, wherein the controller is configured to stop applying the electric field to the color changing layer when the current state of the head up display does not meet the preset condition.

13. A method for protecting a head up display, which is applied to a protection device for the head up display, the method comprising:
providing the protection device, the protection device comprising:
a front cover, a color changing layer, and a rear cover which are disposed in a stack; and
an electrochromic material is provided in the color changing layer, the color changing layer being configured to adjust a light transmittance under an action of an electric field; and
providing a controller coupled to the color changing layer of the protection cover, wherein the controller is configured to input a control signal to the color changing layer to control the electric field;
determining whether a current state of the head up display meets a preset condition, wherein the preset condition comprises that the head up display is in a non-operating state and the illumination intensity is greater than a preset value; and
when the preset condition is met, adjusting the light transmittance of the protection device to protect the head up display.

14. The method according to claim 13, wherein the non-operating state comprises at least one of: the head up display being in a turned-off state; and a vehicle, in which the head up display is located, being in a stopped state.

15. The method according to claim 13, wherein the electric field is applied to the color changing layer when the current state of the head up display meets the preset condition.

16. The method according to claim 13, further comprising, when the preset condition is not met, adjusting the light transmittance of the protection device to an initial value.

17. The method according to claim 16, wherein adjusting the light transmittance of the protection device to an initial value comprises stopping an application of the electric field to the color changing layer.
